(19) United States
(12) Patent Application Publication
(10) Pub. No.: US 2023/0117053 A1
(43) Pub. Date: Apr. 20, 2023

(54) POLYMER SOLAR HEATER

(71) Applicant: Alvaro Fabian BRICIO ARZUBIDE, Guadalajara (MX)

(72) Inventor: Alvaro Fabian BRICIO ARZUBIDE, Guadalajara (MX)

(21) Appl. No.: 17/914,313

(22) PCT Filed: Nov. 13, 2020
(86) PCT No.: PCT/MX2020/050042

§ 371 Date: Sep. 24, 2022

(30) Foreign Application Priority Data
Mar. 23, 2020 (MX) MX/A/2020/003280

(51) Int. Cl. F24S 10/90; F24S 40/58

(52) U.S. Cl. CPC F24S 10/90; F24S 40/58; F24S 2080/015

(57) ABSTRACT

The present invention describes a polymeric solar heater that has the advantage of being able to be operated at different pressures, from low to high pressure without having to make adjustments or modifications, since it has grooved reinforcement flanges on the outside of the tank, which prevents the movement of some reinforcement elements allowing to increase the baric capacity of the tank, another advantage that characterizes the present invention is that the casing and the tank are made of polymers, which allow the temperature to be kept inside for longer, given their low coefficient of thermal conduction. Another significant advantage of the polymeric solar heater is that the collectors have integrated thermal receptors that allow them to capture thermal energy more easily, in addition to having mechanical reinforcements that increase the resistance of said collectors against impacts.

### TECHNICAL FIELD OF THE INVENTION

The present invention is related to the technical field of thermodynamics, thermal energy, renewable energies and physics, since it provides a polymeric solar heater.

### BACKGROUND OF THE INVENTION

Today, it is very natural to have an appliance at home that heats the water for us to shower, wash dishes, wash clothes, clean, etc. Just about 150 years ago there was no equipment or appliance in homes that provided this comfort, and only the most fortunate could heat water at home using firewood or charcoal, using a container that was also used for cooking.

In 1767 Horace de Saussure invented what he called “the hot box”. This consisted of a glass box through which the sun's rays entered, while the interior was painted black. Except for the glass face, all of them had insulating material that allowed heat to be retained inside, in this way, the temperatures reached could reach 109°. This little invention was the first solar collector in the history of solar thermal energy.

In the year 1868, a house painter named Benjamin Waddy Maughan patented the first instantaneous water heater for domestic use that did not use solid fuel. Maughan's invention, who named it Geyser after the jets of hot water that come out of the ground, allowed the cold water in the upper part of the tank to flow smoothly through pipes heated by combustion gases from a burner. on the bottom. But this process was quite dangerous because there was no chimney to remove the gases, which remained in the room where the equipment was installed.

Speaking of the first heater as it is known today, it was the

Norwegian engineer Edwin Ruud who was inspired by Maughan's invention a few years later, in 1880, Ruud patented the first automatic storage tank gas water heater.

In 1909, in a small open-air store in a suburb of Los Angeles, an engineer named William J. Bailey began selling a solar collector for the production of domestic hot water, which can be considered one of the first heaters plots of history, as we know them now. One of the novelties of this heater was that it not only supplied hot water during the day, but also at night.

Water heating is a heat transfer process that uses an energy source to heat water above its initial temperature. Typical domestic uses for hot water include cooking, cleaning, bathing, and space heating; In industry, hot water and steam-heated water have many uses.

Nationwide, water is traditionally heated in vessels known as water heaters, boilers, cauldrons, pots, or coppers. These metal containers that heat a batch of water do not produce a continuous supply of hot water at a preset temperature, the temperature varies with the rate of consumption, and cools as the flow increases.

Appliances that provide a continuous supply of hot water are called water heaters, hot water tanks, boilers, heat exchangers, geysers (South Africa), or heaters; these names depend on the region, and whether they heat potable or non-potable water, are they for domestic or industrial use, and their energy source. In domestic installations, hot potable water for uses other than space heating is also called domestic hot water.

Fossil fuels (natural gas, liquefied petroleum gas or petroleum) or solid fuels are used to heat water, these can be consumed directly or can produce electricity which, in turn, heats the water. The electricity to heat the water can also come from any other electrical source, such as nuclear power or renewable energy.

Alternative energy such as solar power, heat pumps, hot water heat recycling, and geothermal heating can also heat water, often in combination with backup systems powered by fossil fuels or electricity.

Currently there are several types of solar heaters, as technology advances we will see more and more types of solar heaters, but today there are 4 basic types that you can have. It is worth mentioning that the different types of solar heaters have the same objective, to heat water with solar energy.

1. Flat solar heater: They are also known as flat solar collectors, they are divided into two types, with cover and without cover. Cover heaters are basically composed of a glass cover and a fully thermally insulated collector plate inside. Coverless heaters are more common for heating pool water, they are usually made of plastic and are directly exposed to the sun.

2. Evacuated tube solar heaters: They are currently the most widely used for heating water in homes. These are made up of several tubes, each glass tube inside is made of copper, through which the water passes. Unlike the flat ones, they are a little more efficient since, thanks to the shape of the tubes, they absorb the heat of the sun from many directions. One of the biggest advantages is that, thanks to its design, the dispersion of heat towards the outside is reduced to the maximum. However, its biggest disadvantage is that the tubes are fragile and last less than flat collector solar heaters.

3. Concentrating solar heaters: These types of heaters are used more in industries; they are concave and the objective is to project the concentration of solar energy towards a certain point. They are very efficient, but only in direct sunlight. They generally have built-in solar trackers for greater efficiency.

4. Home solar heaters: They can be very efficient, especially if the budget is limited, although they will never be as efficient as one manufactured under industrial conditions, simply because at home or in the workshop you do not have the necessary machinery.

A state-of-the-art search of polymeric solar heaters was conducted, where it was found that different heaters have been developed for this purpose, as mentioned in China utility model document number CN2470756 (Y), published on Jan. 9, 2002, which has the title “SOLAR WATER HEATER”, which describes a solar water heater, which is composed of a support, a reflector, a collector tube, a glass plate, a water tank, pipes and valves. The reflector is a three-curved-sided wide-angle reflection membrane, which is composed of a main reflection face on one side, a supporting reflection face, and a sub-reflection face on the other side. The upper end of the main reflection face is pressed close to the glass plate, and the lower end, that is, the bottom of the reflector, is joined with the lower end of the support reflection face. The upper end of the supporting reflection face is linked with the lower end of the secondary reflection face. The upper end of the sub reflection face is pressed close to the glass plate. The focus of the three reflection faces is directed to the collector tube. The upper part of the utility model water tank has an inverted L-type fitting, and a reducing valve is arranged on the water inlet pipe.

China patent application document number CN1467457 (A), published on Jan. 14, 2004, entitled “INTEGRATED SOLAR WATER HEATER” was also found, which describes an integrated solar water heater comprising a water and a heat exposure surface in which the water heater also includes a transparent honeycomb sheet and a transparent cover plate of the reflection plane unit, the water chamber is arranged at one end of the plane unit of reflection and is located in the closed integrity formed by the reflective plane and the transparent cover plate, the thermal insulation material is arranged on the back, sides of the water chamber and outside the reflection plane. The transparent honeycomb sheet is arranged on the upper surface of the water chamber, the paraboloid and the cylinder face form an integrity in the reflection plane unit, the sunlight that is reflected in the reflection plane is reflected in the lower heat absorbing surface of the water chamber.

Another of the documents found is the Chinese utility model number CN2655121 (Y), published on Nov. 10, 2004, which has the title “REFLECTIVE FACE TO COLLECT SOLAR HEAT”, which refers to a solar collector of the reflective face type, comprising a water storage tank, a support and a collector tube; at least one collector tube is provided on the support; one end of the collecting pipe is connected with the water storage tank; a paraboloid reflector plate is arranged at the bottom of the collector tube; a support shaft is fixed under the reflective plate; both ends of the support shaft are hinged with the support; a connecting rod is arranged on one side of the reflective plate; the support shaft is connected with one end of the connecting rod, and a controller that controls the angle of the reflective plate is connected with the other end of the connecting rod. The device controls the rotation angle of the reflective plate by u microcomputer programming control mode single chip and makes the reflector plate rotate along with the rotation of the sun; the sunbeam reflected by the reflective plate is always directed to the collector tube; and the heat collection efficiency is improved. The device is suitable for centralized hot water supply in buildings; Compared to individual use at home, the price performance ratio of the device is higher.

As can be seen, the above documents refer to solar heaters, but none of the documents show evidence that they can be operated at low, medium and high water pressure without having to make adjustments or modifications, nor do they describe that they are manufactured based on polymeric materials, which improves the conservation of water temperature. They also do not describe having reinforced water collectors that increase their physical resistance.

Finally, the patent document of the United States of America number U.S. Pat. No. 9,587,857 (B2) was found, with a publication date of Mar. 7, 2017, which has the title “INCORPORATED POLYMERIC SOLAR CONCENTRATOR AND SOLAR THERMAL DEVICE” where it is mentioned that Polymeric sheets suitable for use as solar concentrators in solar thermal devices are provided. Solar thermal devices incorporating the polymeric sheets are also provided. Polymeric sheets have two opposing surfaces. A first pattern is defined on the first surface and a second pattern is defined on the second surface. The first pattern is designed to reduce the reflectance of incident light on the first surface relative to the first surface in the absence of the first pattern and to funnel incident light through the sheet to the second surface, it does so by redirecting incident photons on the first surface over a wide range of incident angles towards flow angles that are more closely aligned with the surface normal of the polymer sheet. The second pattern is designed to focus photons transmitted to the second sheet surface onto a focal surface, such as a receptacle containing a heat transfer medium.

The document cited above refers to a solar concentrator, which, although it refers to being made up of polymeric parts, does not mention being able to be operated at low, medium and high water pressure without having to make adjustments or modifications, nor they describe having reinforced water collectors that increase their physical resistance.

### OBJECT OF THE INVENTION

It is therefore an object of the present invention to provide a polymeric solar heater, which solves the aforementioned problems.

### BRIEF DESCRIPTION OF THE FIGURES

The characteristic details of this novel polymeric solar heater are clearly shown in the following description and in the accompanying figures, as well as an illustration thereof, and following the same reference signs to indicate the parts shown. However, said figures are shown by way of example and should not be considered as limiting the present invention.

FIG. 1 shows a front perspective view of the polymeric solar heater.

FIG. 2 shows a left view of the longitudinal section with detail of the connection of the collector of the polymeric solar heater.

FIG. 3 shows a front view of the polymeric solar heater tank.

FIG. 4 shows a top view of the collector of the polymeric solar heater.

FIG. 5 shows a side view of the collector of the polymeric solar heater.

FIG. 6 shows a left view of the longitudinal section with detail of the inlet of the polymeric solar heater.

FIG. 7 shows a right view of the longitudinal section with detail of the outlet of the polymeric solar heater.

FIG. 8 shows a left view of the longitudinal section with detail of the safety valve of the polymeric solar heater.

FIG. 9 shows a detailed view of the safety valve of the polymeric solar heater.

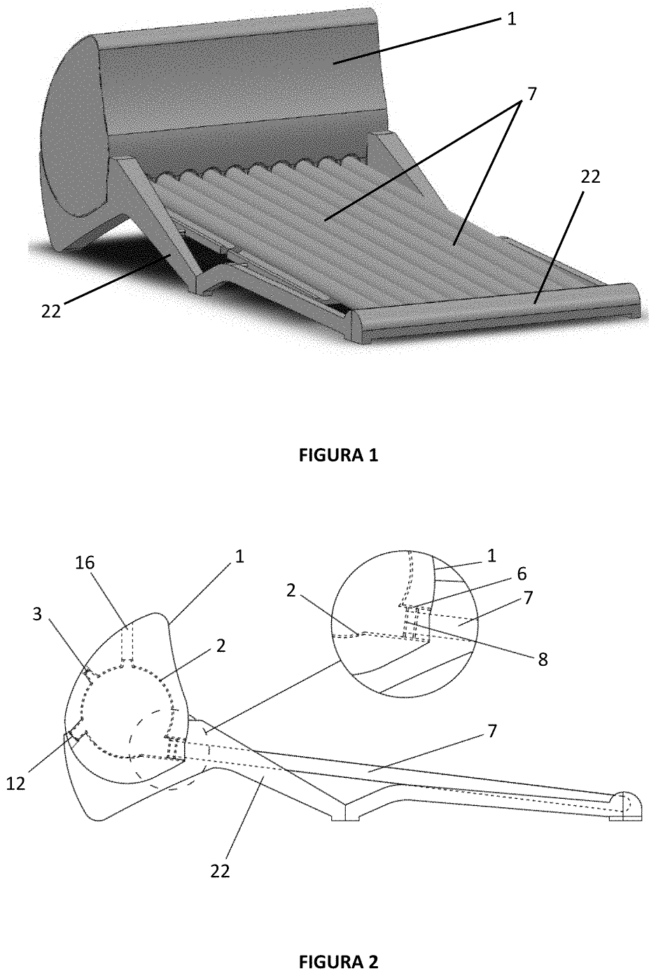

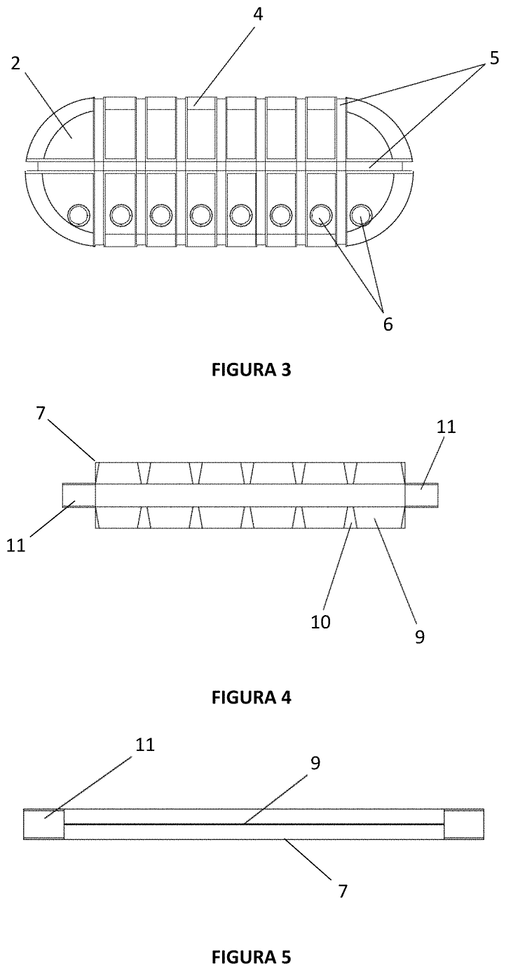

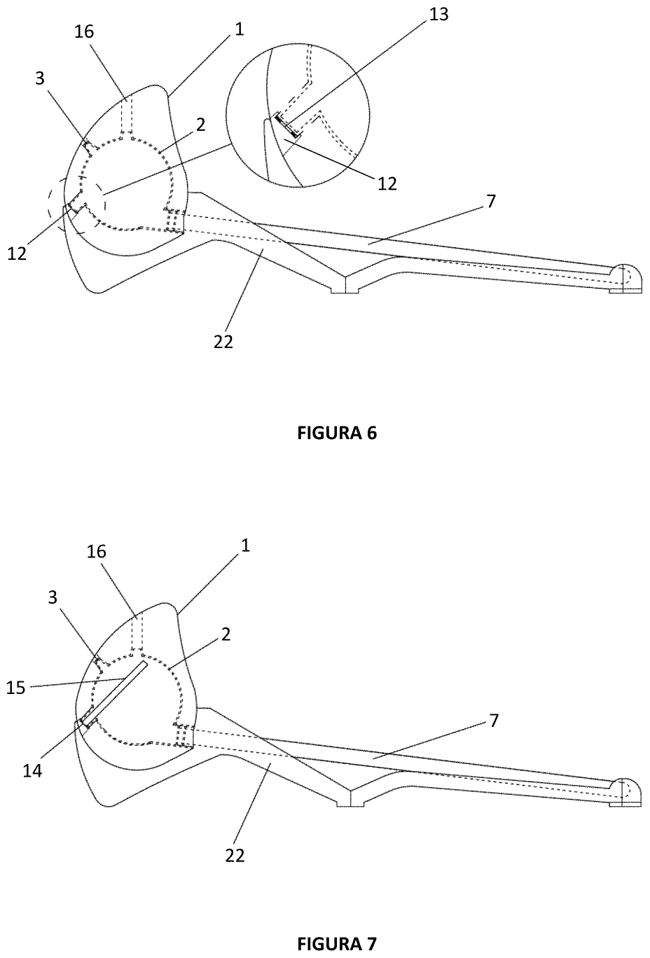

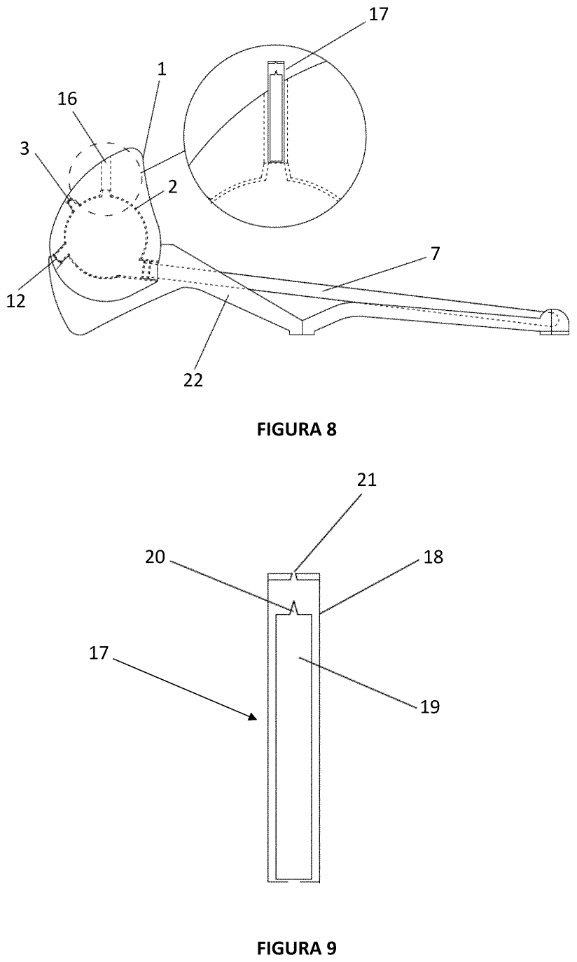

### DETAILED DESCRIPTION OF THE INVENTION

For a better understanding of the invention, the parts that make up the polymeric solar heater are listed below:

1. Casing

2. Tank

3. Separator

4. Reinforcement eyebrow

5. Strengthening elements

6. Turbinate

7. Collector

8. Hydraulic seal

9. Thermal receptors

10. Mechanical reinforcements

11. Connector

12. Input jack

13. Security plate

14. Outlet socket

15. Outlet duct

16. Pressure outlet

17. Safety valve

18. Valve body

19. Float

20. Pivot

21. Relief duct

22. Foundation

With reference to the figures, the polymeric solar heater is made up of a casing (1) preferably made of a polymer which can be polyethylene or polypropylene, said casing (1) is configured to house a tank (2) which is preferably paraboloid-shaped mind, and of a polymer which can be polyethylene or polypropylene, and is configured to store a liquid; The construction materials of the casing (1) and the tank (2) allow the temperature to be kept inside for a longer time, given their low coefficient of thermal conduction.

A separator (3) which is preferably conical, is installed between the casing (1) and the tank (2), allowing to leave a free space where an insulating material can be placed, apply vacuum or contain air, and thus improve, the time of conservation of the temperature of the liquid that is inside the tank (2).

A reinforcing flange (4) preferably grooved, is located on the outer periphery of the tank (2), which is configured to prevent the movement of reinforcing elements (5) which can be straps, belts or clamps, preferably metallic; Said reinforcing elements (5) are installed in different positions outside the tank (2), which allow the baric capacity of the tank (2) to be reinforced.

At least one cone (6) is located at the level of the lower base on the front face of the tank (2), configured to install a collector (7) which is preferably glass, cylindrical in shape and double-walled; said collector (7) is configured to capture the thermal energy obtained from solar radiation and transfer said energy to the liquid contained within the collector (7); the configuration of the cone (6) and the collector (7) allows to maintain hot water in the entire tank since the collector (7) remains aligned in the lower base of the tank (2), for which water spaces are eliminated with little or no circulation, and when liquid enters said tank (2) it comes into direct contact with the liquid contained in the collector (7) improving the efficiency of the polymeric solar heater; a hydraulic seal (8) is installed between the cone (6) and the collector (7) which is configured to prevent liquid leakage. The hydraulic seal (8) can be made of silicone, rubber, PVA, viton, nitrile, teflon or a combination of the above.

A plurality of thermal receivers (9) which are preferably prismatic in shape are installed inside the double wall of the collector (7), and are configured to capture thermal energy and improve the efficiency of the polymeric solar heater.

A plurality of mechanical reinforcements (10) are installed between the thermal receptors (9) which are configured to support said thermal receptors (9) and provide firmness to the collector (7); a connector (11) preferably cylindrical in shape is installed at each of the ends of the manifold (7), this configuration allows two or more manifolds (7) to be connected in a linear manner.

An inlet port (12) which is preferably internally threaded, is located in the lower part of the rear face of the tank (2) and exits through the outside of the casing (1) and is configured to connect a line feeding; a safety plate (13) with a preferably square prismatic shape, and which has a hole in its center is installed on the outside of the inlet (12), this configuration allows the power line to be installed, protecting the thread from damage of the input socket (12) if said power line were to turn more than required.

An outlet (14) which is preferably threaded inside, is installed in the lower part of the rear face of the tank (2) which comes out to the outside of the casing (1) and is configured to connect a line output; the safety plate (13) is installed on the outside of the outlet (14), this configuration allows the outlet line to be installed, protecting the internal thread of the outlet (14) from damage if said outlet line is damaged. will turn more than required; one end of an outlet duct (15) is installed in the outlet (14) on the inside of the tank (2), where the opposite end of said outlet duct (15) is at the top of the interior of the tank (2), this configuration allows liquid to be supplied from the highest part of said tank (2), since in that position the liquid has a higher temperature.

A pressure outlet (16) preferably with an internal thread, is located in the upper part of the tank (2) which exits through the upper part of the casing (1), and is configured so that a safety valve (17) is install inside.

The safety valve (17) is made up of a valve body (18) preferably cylindrical in shape, which has a float (19) housed inside; a pivot (20) preferably conical in shape, is located in the upper part of the float (19) which joins with a relief duct (21) that is located in the upper part of the body valve (18), this configuration allows the float to rise to close the safety valve (17) when the tank (2) fills with water or to release steam pressure by opening the safety valve (17) when the temperature of the tank (2)) exceeds the pressure established in said safety valve (17) and thus avoid damage to the polymeric solar heater.

A base (22) is installed in the lower part of the casing (1) and of the collectors (7) which is configured to support the polymeric solar heater and to be able to install it on any surface and allow it to be stable.

A reflective cover (not illustrated) is installed on the front of the casing (1) which is configured to direct the thermal waves from the sun to the collector (7).

### PREFERRED EMBODIMENT OF THE INVENTION

### Examples

The following examples illustrate a preferred way of carrying out the present invention, so they should not be considered as limiting it.

Example 1. Connection and supply of hot water to the house with the polymeric solar heater.

With reference to the aforementioned figures, a water supply tube is installed in the inlet (12), then the outlet (14) is connected to the hot water supply line of a house, then it is installed. open the tap of the water supply to fill the tank (2) and the collectors (7), in such a way that with the solar radiation, the collectors (7) capture and transfer the thermal energy to the water that is inside them, Subsequently, due to the temperature difference in the water that is inside the tank (2), the water with the highest temperature rises, remaining in the upper part of said tank (2), where the outlet duct (15) is in contact with the hottest water.

Once the water in the tank (2) is hot, a faucet is opened inside the house, which could be from the kitchen for washing utensils, the hot water that is inside the tank (2) comes out through the outlet duct (15) to be redirected to the hot water supply line of the house.

The invention has been sufficiently described so that a person with average knowledge in the matter can reproduce and obtain the results that we mention in the present invention. However, any skilled person in the technical field that the present invention is responsible for may be able to make modifications not described in this application, however, if for the application of these modifications in a given structure or in the manufacturing process of this, the matter claimed in the following claims is required, said structures should be included within the scope of the invention.

1. A polymeric solar heater, characterized in that it comprises: a casing (1) configured to house a tank (2); a separator (3) is installed between the casing (1) and the tank (2) allowing a free space to be left between them; at least one reinforcing flange (4) is located on the outer periphery of the tank (2) configured to prevent the movement of some reinforcing elements (5), which are installed in different positions on the outside of the tank (2); at least one cone (6) is at the level of the lower base on the front face of the tank (2), said cone (6) is configured so that a collector (7) is installed; a hydraulic seal (8) is installed between the cone (6) and the collector (7); a plurality of thermal receivers (9) are installed inside the double wall of the collector (7); a plurality of mechanical reinforcements (10) are installed between the thermal receivers (9); a connector (11) is installed in each of the ends of the collector (7); an inlet port (12) is located in the lower part of the rear face of the tank (2) and exits through the outside of the casing (1); an outlet (14) is installed in the lower part of the rear face of the tank (2) which comes out of the casing (1); a security plate (13) is installed on the outside of the input socket (12) and the output socket (14); an outlet duct (15) is installed by means of one of its ends in the outlet outlet (14) on the inside of the tank (2); a pressure outlet (16) is located in the upper part of the tank (2) which exits through the upper part of the casing (1), said pressure outlet (16) is configured so that a safety valve (17) is installed inside it; a base (22) is installed in the lower part of the casing (1) and the collectors (7); and, a reflective cover (not shown) is installed on the front of the casing (1).

2. The heater of claim 1 characterized in that the casing (1) and the tank (2) are preferred mind of a polymer.

3. The heater of the preceding claim characterized in that the polymer is polyethylene or polypropylene.

4. The heater of claim 1 characterized in that the separator (3) is preferably conical.

5. The heater of claim 1 characterized in that the collector (7) is cylindrical in shape.

6. The heater of claims 1 and 5 characterized in that the collector (7) has a double wall.

7. The heater of claims 1, 5 and 6, characterized in that the collector (7) is preferably made of glass.

8. The heater of claim 1 characterized in that the hydraulic seal (8) can be made of silicone, Rubber, PVA, viton, nitrile, teflon or a combination of the above.

9. The heater of claim 1, characterized in that the thermal receptors (9) are preferably prismatic in shape.

10. The heater of claim 1 characterized in that the connector (11) is preferably cylindrical in shape.

11. The heater of claim 1 characterized in that the input socket (12) and the outlet socket (14) are preferably threaded inside.

12. The heater of claim 1, characterized in that the safety plate (13) is prismatic in shape.

13. The heater of claim 12 characterized in that the prismatic shape is preferably square.

14. The heater of claim 1 characterized in that the pressure outlet (16) preferably has an internal thread.

15. The heater of claim 1 characterized in that the safety valve (17) is made up of a valve body (18) which has a float (19) housed inside it, a pivot (20) is in the upper part of the float (19) which joins with a relief duct (21) located in the upper part of the valve body (18).

16. The heater of claim 1 characterized in that the valve body (18) is preferably cylindrical in shape.

17. The heater of claim 1 characterized in that the pivot (20) is preferably conical in shape.
